(19) United States
(12) Patent Application Publication
(10) Pub. No.: US 2017/0061258 A1
(43) Pub. Date: Mar. 2, 2017

(54) METHOD, APPARATUS, AND COMPUTER PROGRAM PRODUCT FOR PRECLUDING IMAGE CAPTURE OF AN IMAGE PRESENTED ON A DISPLAY

(71) Applicant: Nokia Technologies OY, Espoo (FI)

(72) Inventors: Xin Chen, Evanston, IL (US); Ruigang Yang, Lexington, KY (US)

(21) Appl. No.: 14/835,106

(22) Filed: Aug. 25, 2015

(51) Int. Cl. G06K 9/66; H04N 7/18; G06N 3/08; G06K 9/62

(52) U.S. Cl. CPC G06K 9/66; G06K 9/6269; H04N 7/183; G06N 3/08

(57) ABSTRACT

An apparatus may be provided including at least one processor and at least one memory including computer program code. The at least one memory and the computer program code may be configured to, with the processor, cause the apparatus to perform various operations. Those operations may include: receiving a plurality of positive sample images comprising images of image capture devices; receiving a captured image captured from an image capture device; determining if the captured image comprises an image of an image capture device; and causing an image provided for presentation on a display to be changed in response to the captured image comprising an image of an image capture device. The apparatus may optionally be caused to analyze the plurality of positive sample images including images of image capture devices to learn to detect images of image capture devices in a captured image.

### TECHNOLOGICAL FIELD

Embodiments of the present invention relate generally to a method, apparatus, and computer program product for precluding image capture of an image presented on a display, and more specifically, to determining when an image capture device is positioned to capture an image of the image presented on a display and responding by changing the image that is presented on the display.

### BACKGROUND

Maintaining confidentiality of information has long been a requirement in many fields, such as the medical field and the legal profession. Confidentiality also is important in business to preclude competitors from gaining insight on business practices and technologies, and in personal information, such as information shared between friends or spouses. In the past when information was recorded on physical medium, such as paper, confidentiality of this information was more easily maintained through tracking, securing, and destruction of the physical medium including the confidential information. In the digital age, information may be copied, printed, transmitted electronically, and presented for display prolifically with few controls capable of limiting the extent to which information can be replicated and shared.

### BRIEF SUMMARY

A method, apparatus and computer program product are therefore provided according to an example embodiment of the present invention for facilitating detection of an image capture device within an image, and more specifically, for precluding image capture of an image presented on a display through changing the image based on the detection of an image capture device.

According to an example embodiment of the invention, an apparatus may be provided including at least one processor and at least one memory including computer program code. The at least one memory and the computer program code may be configured to, with the processor, cause the apparatus to perform various operations. Those operations may include: receiving a plurality of positive sample images comprising images of image capture devices; receiving a captured image captured from an image capture device; determining if the captured image comprises an image of an image capture device; and causing an image provided for presentation on a display to be changed in response to the captured image comprising an image of an image capture device. The apparatus may optionally be caused to analyze the plurality of positive sample images including images of image capture devices to learn to detect images of image capture devices in a captured image. Analyzing the plurality of positive sample images comprising images of image capture devices may include applying a machine learning algorithm to the plurality of positive sample images. The machine learning algorithm may include a deep convolutional neural network and/or a support vector machine training algorithm. The machine learning algorithm may be performed to determine if the captured image includes an image capture device.

According to some embodiments, causing the apparatus to change that which is provided for presentation on a display may include ceasing to present an image that was presented immediately before the captured image was determined to include an image capture device. Causing the apparatus to change that which is provided for presentation on a display may include providing for presentation of only a portion of an image that was provided for presentation immediately before the captured image was determined to include an image capture device. The apparatus may optionally be caused to receive a plurality of negative sample images not including images of image capture devices to facilitate machine learning for determining the presence of an image capture device in an image.

Embodiments described herein may provide a method including: receiving a plurality of positive sample images comprising images of image capture devices; receiving a captured image captured from an image capture device; determining if the captured image comprises an image of an image capture device; and causing an image provided for presentation on a display to be changed in response to the captured image comprising an image of an image capture device. The method may optionally include analyzing the plurality of positive sample images including images of image capture devices to learn to detect images of image capture devices in a captured image. Analyzing the plurality of positive sample images comprising images of image capture devices may include applying a machine learning algorithm to the plurality of positive sample images. The machine learning algorithm may include a deep convolutional neural network and/or a support vector machine training algorithm. The machine learning algorithm may be performed to determine if the captured image includes an image capture device.

According to some embodiments, causing that which is provided for presentation on a display may include ceasing to present an image that was presented immediately before the captured image was determined to include an image capture device. Causing the apparatus to change that which is provided for presentation on a display may include providing for presentation of only a portion of an image that was provided for presentation immediately before the captured image was determined to include an image capture device. The method may optionally include receiving a plurality of negative sample images not including images of image capture devices to facilitate machine learning for determining the presence of an image capture device in an image.

Embodiments described herein may include a computer program product including at least one non-transitory computer readable storage medium having computer-executable program code instructions stored therein. The computer-readable program code instructions including program code instructions for: receiving a plurality of positive sample images comprising images of image capture devices; receiving a captured image captured from an image capture device; determining if the captured image comprises an image of an image capture device; and causing an image provided for presentation on a display to be changed in response to the captured image comprising an image of an image capture device. The program code instructions may optionally include program code instructions for analyzing the plurality of positive sample images including images of image capture devices to learn to detect images of image capture devices in a captured image. The program code instructions for analyzing the plurality of positive sample images comprising images of image capture devices may include program code instructions for applying a machine learning algorithm to the plurality of positive sample images. The machine learning algorithm may include a deep convolutional neural network and/or a support vector machine training algorithm. The machine learning algorithm may be performed to determine if the captured image includes an image capture device.

According to some embodiments, the program code instructions for causing that which is provided for presentation on a display may include program code instructions for ceasing to present an image that was presented immediately before the captured image was determined to include an image capture device. The program code instructions for causing the apparatus to change that which is provided for presentation on a display may include program code instructions for providing for presentation of only a portion of an image that was provided for presentation immediately before the captured image was determined to include an image capture device. The computer program product may optionally include program code instructions for receiving a plurality of negative sample images not including images of image capture devices to facilitate machine learning for determining the presence of an image capture device in an image.

Embodiments described herein may provide an apparatus including: means for receiving a plurality of positive sample images comprising images of image capture devices; means for receiving a captured image captured from an image capture device; means for determining if the captured image comprises an image of an image capture device; and means for causing an image provided for presentation on a display to be changed in response to the captured image comprising an image of an image capture device. The apparatus may optionally include means for analyzing the plurality of positive sample images including images of image capture devices to learn to detect images of image capture devices in a captured image. The means for analyzing the plurality of positive sample images comprising images of image capture devices may include means for applying a machine learning algorithm to the plurality of positive sample images. The machine learning algorithm may include a deep convolutional neural network and/or a support vector machine training algorithm. The machine learning algorithm may be performed to determine if the captured image includes an image capture device.

According to some embodiments, the means for causing that which is provided for presentation on a display may include means for ceasing to present an image that was presented immediately before the captured image was determined to include an image capture device. The means for causing the apparatus to change that which is provided for presentation on a display may include means for providing for presentation of only a portion of an image that was provided for presentation immediately before the captured image was determined to include an image capture device. The apparatus may optionally include means for receiving a plurality of negative sample images not including images of image capture devices to facilitate machine learning for determining the presence of an image capture device in an image.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is an example of an apparatus which may benefit from example embodiments of the present invention;

FIG. 4 is a diagram of an example embodiment of a deep convolutional neural network for recognizing image capture devices in an image according to the present invention; and

FIG. 5 is a flowchart of a method for precluding image capture of an image presented on a display according to an example embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

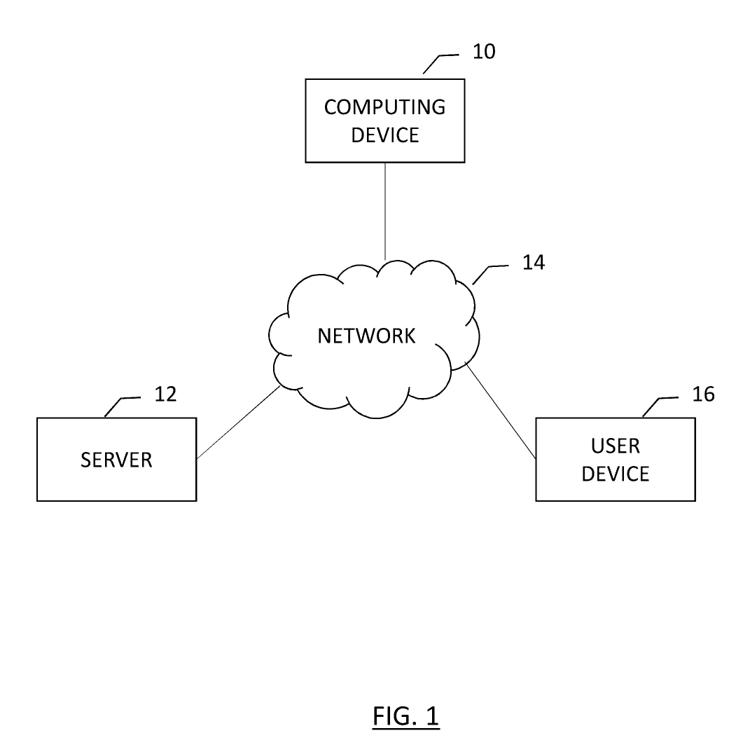

FIG. 1 illustrates a system that supports communication, either wirelessly or via a wireline, between a computing device 10 and a server 12 or other network entity (hereinafter generically referenced as a “server”). As shown, the computing device and the server may be in communication via a network 14, such as a wide area network, such as a cellular network or the Internet, or a local area network. However, the computing device and the server may be in communication in other manners, such as via direct communications between the computing device and the server. The user device 16 will be hereinafter described as a mobile terminal, but may be either mobile or fixed in the various embodiments

The computing device 10 and user device 16 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

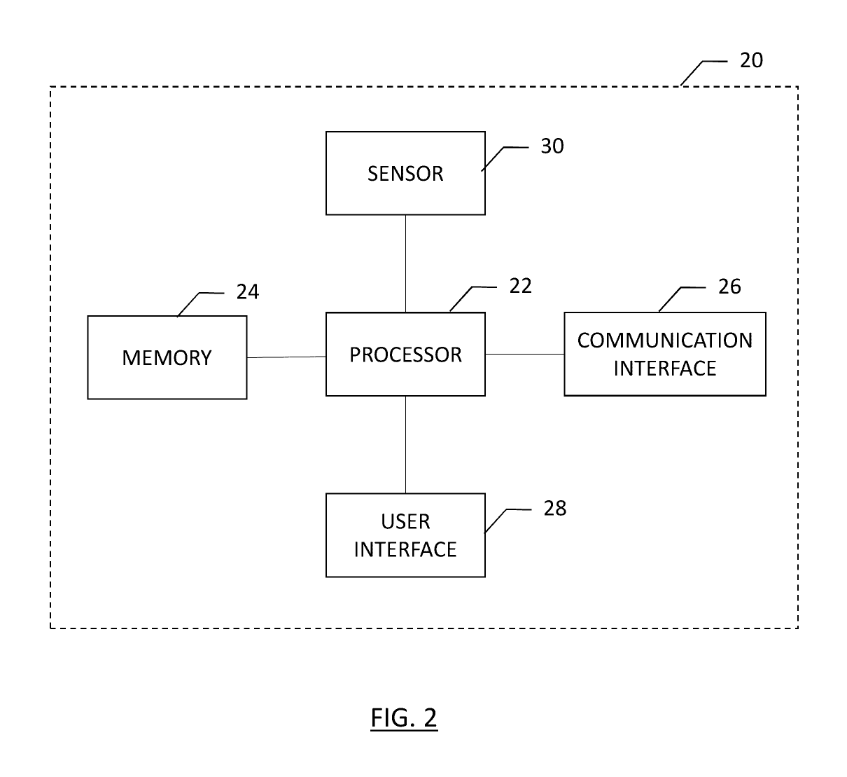

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

The apparatus 20 may further include one or more sensors 30. The sensors may include, for example, an image sensor, such as a camera, a video recorder or the like, which may be configured to capture images. The captured images may be of an environment, of a user (e.g., a web cam), or the like. Sensors 30 may optionally include one or more temperature sensor, humidity sensor, light sensor, audio sensor, motion sensor (e.g., an accelerometer), position sensor (e.g., GPS receiver), or any type of sensor to detect a characteristic of the apparatus 20, an environment of the apparatus, or a condition of the apparatus.

Many types of devices can be used to capture images, such as conventional digital point-and-shoot cameras, conventional film-based cameras, Single Lens Reflex (SLR) cameras, Digital Single Lens Reflex (DSLR) cameras, video/television cameras, body-worn cameras, and mobile devices equipped with image sensors, such as cellular phones, personal digital assistants (PDAs), laptop computers, tablet computers, etc. As such, images can be captured through a wide range of devices that are omnipresent in modern environments. As the ubiquity of devices capable of capturing images increases, there tends to be a commensurate increase in concern for privacy. Personal information or images may have a high expectation of privacy. Similarly, confidential documents, trade secrets, information relating to national security, security practices, and other information may also have a high expectation of privacy and confidentiality. With the ubiquity of image capture devices, this privacy and confidentiality has the potential to be easily compromised.

Information stored electronically, such as in the form of documents, pictures, spreadsheets, presentations, etc., may be configured for presentation on a display. This presentation may occur on a display of a desktop computer, laptop, tablet computer, mobile terminal such as a cellular phone, etc. The ability to view this information in widely varying environments provides a high level of convenience, but also introduces opportunities for potential breach of privacy and confidentiality. When information or an image is presented on a display, it may be possible for an image capture device to capture an image of that display depicting the private or confidential information.

According to an example embodiment of the present invention, an apparatus or computer program product may be provided to implement or execute a method, process, or algorithm that precludes screen capture by an image capture device. A device, such as apparatus 20, may be configured to detect the presence of an image capture device through image analysis of an image captured by sensor 30. Many devices, such as cellular phones, laptop computers, tablet computers, and many desktop computers, include image capture sensors, such as web-cams or cameras configured to capture an image of a user while they are viewing images presented on a display of the device. Such cameras are often used for video conferencing, video calls, etc. According to embodiments described herein, when certain information or images are presented on a display (e.g., user interface 28 of apparatus 20) that include private or confidential information, in response to detection of an image capture device through an image sensor 30 of the apparatus, the display may cease to present the private or confidential information.

According to some embodiments described herein, the information presented for display may be of a private or confidential nature, or the information may be public or suitable for public viewing. The determination of whether to cease to present information on a display may be based on a number of criteria. For example, if a device, such as apparatus 20, is running a program such as a tax-preparation software program, or if the apparatus 20 is operating over a network (e.g., network 14) to access a website in which credit card information is provided for display, the processor 22 may be aware of the private nature of the program or website and presume that any information presented for display is of a private or confidential nature. The processor 22 may be made aware of the private nature of the program or website through, for example, features of the software, such as an encryption method, or a flag that the software developer has inserted in the program to indicate to the processor that information displayed may be private. With regard to websites, information may be presumed to be private or confidential when a website is operating under a secure Hypertext Transfer Protocol (HTTP), such as HTTP over TLS (Transport Layer Security), HTTP over SSL (Secure Sockets Layer), or HTTPS (HTTP Secure), for example. Optionally, a user may configure embodiments described herein such that any information presented on a display may be private or confidential. Such a setting may also be useful for employers to preclude employees or others from capturing images of confidential security or client related data, for example.

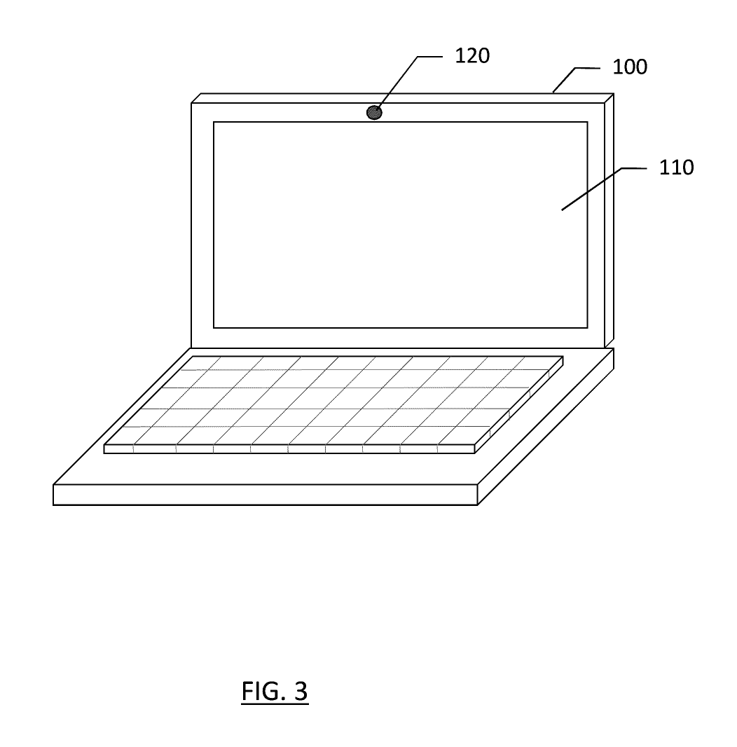

FIG. 3 illustrates an example embodiment of an apparatus that may be used in accordance with embodiments of the present invention. The illustrated apparatus comprises a laptop computer 100 having a display 110. The laptop 100 further includes a camera 120 generally used as a web cam for video conferencing and video calls. The display 110 may be configured to present information to a user, and this information may include, for example, confidential information related to the user's healthcare. While the confidential healthcare information is being presented on display 110, the camera 120 may be operable to capture images of the field of view, which may generally include most positions from which the display 110 may be visible. In response to the camera 120 determining that an image capture device (e.g., a cell phone with a camera, a digital point-and-shoot camera, etc.) is in the field of view of the camera 120, the confidential information regarding the user may cease to be presented on display 110. The determination of whether or not the field of view of the camera 120 includes an image capture device may be performed, for example, by processor 22 based on images captured by sensor 30. The determination of whether an image capture device is in the field of view may be performed, for example, by the method described below. The processor 22 may also be configured to provide the command to the display 110 (e.g., of user interface 28), to cease to present the confidential information on the display.

According to some examples provided herein, an apparatus, such as laptop 100 or apparatus 20 embodied by the user device 16 may be configured to receive an image, for example from camera 120 or sensor 30. The image may be that of an environment in which the apparatus 20 is located, and the image may depict the field of view of the sensor 30. Methods described herein may use deep learning or deep machine learning to determine whether or not an image capture device, such as a camera or cell phone with a camera, appears in an image captured by the sensor 30 of the apparatus 20.

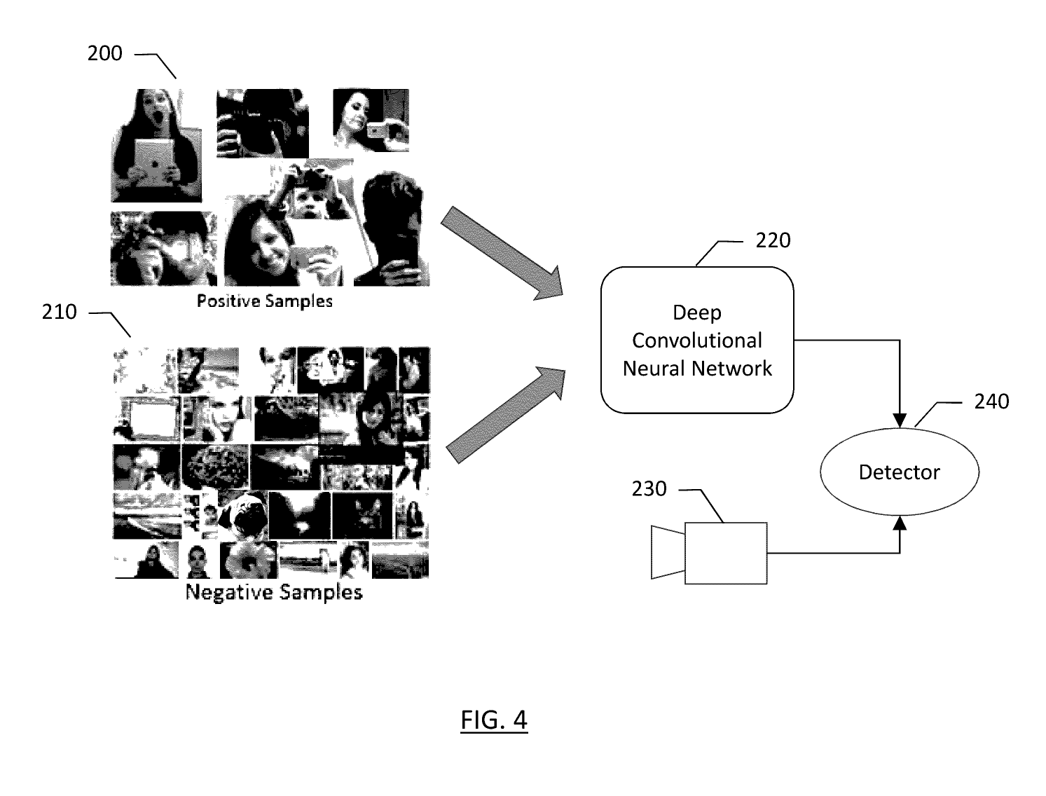

The deep learning technique to detect an image capture device may implement deep neural networks (DNN) or deep convolutional neural networks (DCNN). A DCNN technique used to detect an image capture device may be based on one or both of positive samples and negative samples, as illustrated in FIG. 4. Positive samples 200 may be compiled manually, at least initially, while positive samples may be collected through an automated method once detection of an image capture device in an image is robust and reliable. Images may be given a confidence level with respect to whether or not an image capture device is believed to be in the image, and if the confidence level is above a threshold, that image may be added to the positive samples to strengthen the database and improve the deep convolutional neural network. Negative samples 210 may also be collected in a similar manner, with a confidence level established as to whether or not an image capture device is detected in the image. These two databases of samples may be used by the deep convolutional neural network 220 to reliably determine if an image captured by an image capture device 230 (which may be sensor 30 of apparatus 20, or camera 120 of laptop 100) includes an image capture device in the field of view. The determination may be made at a detector 240 as illustrated in FIG. 4, which may be embodied by the processor 22 of apparatus 20, or one or more processors of laptop 100, for example.

Another method to determine whether or not an image capture device is in the field of view of the sensor 30 can include a support vector machine (SVM) that can use learning algorithms to analyze and recognize patters. The SVM can use a set of training examples, such as the positive samples 200 and negative samples 210. The SVM training algorithm can build a model that assigns a captured image to one of the two categories of positive (e.g., the image includes an image capture device) or negative (e.g., the image does not include an image capture device). While deep learning using deep convolutional neural networks and support vector machine techniques are described herein as vision-based detection algorithms, other vision-based detection algorithms may also be implemented.

According to some example embodiments, in order to determine whether or not an image capture device is in the field of view of the sensor 30, the captured image may be compared to a database of positive samples, or optionally, a database of images of image capture devices which may be gathered through automated or manual scouring of a network such as the Internet. If the captured image includes an object that is identical to or bears a substantial similarity to the image capture device images or the positive samples containing images of image capture devices, the processor may consider the captured image to include an image capture device. An image capture device of a captured image may not identically match a positive sample or an image of an image capture device, such that a degree of similarity may be used to positively identify an image capture device in the captured image. The processor 22 may conduct an image analysis of the captured image and the positive samples/images of image capture devices, and as a result, determines a likelihood that the object in the captured image is an image capture device if the object being determined to be an image capture device exceeds a predefined threshold of confidence. For example, if an object in a captured image is 90% similar to an image of an image capture device (using shapes, shadows, detail lines, relative sizes, etc.), then the processor 22 may determine that the captured image includes an image capture device. Optionally, the captured image may be compared against both the positive samples and the negative samples, and if the captured image is more similar to the positive samples, a determination is made that the captured image includes an image capture device.

Upon detecting an image capture device in an image of an environment of a device, such as laptop 100 using camera 120, the display may alter that which is displayed to cease to display private or confidential information. For example, if a person is viewing personal pictures on the display 110, and camera 120 captures an image that includes what is determined to be an image capture device (e.g., as determined by processor 22, for example using DCNN), the processor 22 may cause the personal pictures to cease to be presented on display 110. This may be accomplished by ceasing to present anything on the display 110 leaving the display blank, or alternatively blurring or otherwise obscuring the personal pictures. Further, a message may be presented on the display indicating that an image capture device has been detected in the field of view of camera 120. In this manner, a user may be alerted to the presence of an image capture device and understand why the information they were viewing was obscured or removed. This feature may also serve as a warning to a person attempting to capture an image of that which is presented on the display 110. The person may not be aware that what they are attempting to capture an image of is established to be private or confidential, and a message presented across the display may alert the person to that fact.

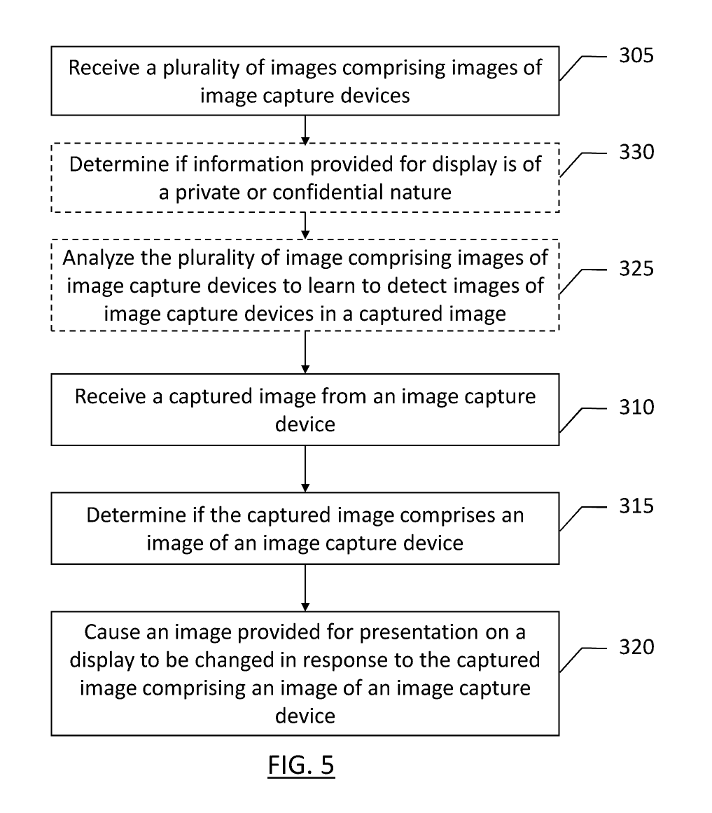

FIG. 5 illustrates an example flowchart of the example operations performed by a method, apparatus, and computer program product in accordance with an embodiment of the present invention. It will be understood that each block of the flowchart and combinations of blocks in the flowchart may be implemented by various means, such as hardware, firmware, processor, circuitry, and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 5, when executed, convert a computer or processing circuitry into a particular machine configured to perform an example embodiment of the present invention. Accordingly, the operations of FIG. 5 define an algorithm for configuring a computer or processing to perform an example embodiment. In some cases, a general purpose computer may be provided with an instance of the processor which performs the algorithms of FIG. 5 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included as shown by the blocks having a dashed outline in FIG. 5. It should be appreciated that each of the modifications, optional additions or amplifications below may be included with the operations above either alone or in combination with any others among the features described herein.

In some example embodiments, a method, apparatus and computer program product may be configured for facilitating image capture device recognition, and more specifically, for facilitating screen capture prevention using improved image processing techniques. For example, image capture device recognition may be improved by utilizing image-capture-device-present (positive)/image-capture-device-not-present (negative) segmentation by, for example, applying deep learning techniques to segment an image of an environment into image capture device and non-image capture device regions. Example embodiments of the present invention may be useful when, for example, the sensor 30 is an image capture device itself such as a visible wavelength camera or the like, and the image is captured in unconstrained environments, which often contain more noise (e.g., caused by users, movement, environment reflections, shadows, or the like).

In accordance with an example embodiment of the present invention, segmentation of an image by applying deep learning techniques may include deep learning based segmentation, segmentation refinement, and image capture device boundary recognition. An apparatus, such as apparatus 20 embodied by the user device 16, may be configured to receive an image (e.g., via sensor 30). The image may be that of an environment of the apparatus including background, foreground, people, objects, etc. Deep learning networks may be applied to segment out the image capture device region or to segment the image capture device region and the non-image capture device region of the image of the environment. The deep learning networks may be convolutional neural networks (CNN). That is, the apparatus may be configured to perform CNN based segmentation. The deep learning networks, or in some cases, the CNNs, may be trained by an annotated image capture device image data set. This may then provide an output of a binary mask image that marks all possible pixels of an image capture device image.

The apparatus, such as apparatus 20 embodied by the user device 16, may be configured to generate a binary mask image from the image, the binary mask image identifying a plurality of target pixels from among the plurality of pixels. The apparatus therefore may include means, such as the processor 22, for generating a binary mask image from the image, where the binary mask image identifies the plurality of target pixels from the plurality of pixels. As the binary mask image may include misclassified pixels (e.g., pixels identified as part of an image capture device when they are otherwise environment), a curve fitting process or shape fitting process may be applied to further refine the segmentation results. Any estimated image capture device pixels outside of the boundary may then be removed in a method of segmentation refinement.

Labels may be applied to each of the plurality of pixels of the image of the environment, the label identifying the pixels as target (e.g., part of an image capture device) or non-target (e.g., otherwise part of the environment). The application of labels may be based on learned parameters. The plurality of pixels identified as target pixels may be output to the binary mask image for identification of the image capture device within the captured image.

As one of ordinary skill in the art, in machine learning, a CNN is a type of feed-forward artificial neural network where the individual neurons are tiled in such a way that they respond to overlapping regions in the visual field and are widely used models for image and video recognition. According to some embodiments, image patches from training images of image capture devices may be randomly sampled. Many image patches in an image are of objects, people, background, etc., that may be close to an image capture device. These image patches may be normalized, such as with dark backgrounds.

Based on the target pixels that comprise the potential image of an image capture device, the group of target pixels may be compared against positive samples including image capture devices, or images of image capture devices themselves. This comparison may be based on shape recognition, pattern detection, relative sizes (e.g., the size of a device relative to a user's hand, or the size of an apparent lens relative to the body of an apparent image capture device), markings (e.g. logos or brand names), etc. Each of these factors may contribute to the determination of whether the captured image includes an image capture device.

FIG. 5 is an example flowchart illustrating a method for identifying an image capture device within an environment of a device and ceasing to present personal or confidential information on the display in response to detection of the image capture device. According to the illustrated example, an apparatus, such as apparatus 20 embodied by the user device 16, may be configured to receive a plurality of images at 305 where the images comprise images of image capture devices. The apparatus embodied by user device 16 therefore includes means, such as the processor 22, the communication interface 26 or the like, for receiving images, the images each comprising an image of an image capture device. These images are identified as “positive” samples. A plurality of images may optionally be received that do not include image capture devices, where those images are identified as “negative” samples. A captured image may be received from an image capture device at 310, for example by apparatus 20 through an image sensor 30. A determination may then be made if the captured image includes an image of an image capture device at 315. The determination may be performed, for example, by processor 22 of the apparatus 20. An image or information provided for presentation on a display may be changed in response to the captured image comprising an image of an image capture device at 320. The change to the image may be caused by the processor 22, by obscuring or altering that which is presented for display on the user interface 28. The image provided for display may be changed in various manners as described above, such as through pixilation or blurring of the image, ceasing to display the image altogether, overlaying the image with a warning to a user, or the like. As illustrated in FIG. 5 as an optional operation, the positive samples or plurality of images comprising images of image capture devices may be used to learn and/or generate an algorithm for detecting images of image capture devices at 325. According to some embodiments, before steps are taken to mask or conceal information in response to an image capture device being recognized in an environment, a determination may be made, as shown at 330, as to whether the information provided for display is of a private or confidential nature. If it is not, then no further action needs to be taken and analysis of images of the environment for image capture devices does not need to be conducted. However, if the information provided for display is determined to be of a private or confidential nature, the analysis of images of the environment may be performed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to at least:
receive a plurality of positive sample images comprising images of image capture devices;
receive a captured image captured from an image capture device;
determine if the captured image comprises an image of an image capture device; and
cause an image provided for presentation on a display to be changed in response to the captured image comprising an image of an image capture device.

2. An apparatus according to claim 1, wherein the apparatus is further caused to:
analyze the plurality of positive sample images comprising images of image capture devices to learn to detect images of image capture devices in a captured image.

3. An apparatus according to claim 2, wherein analyzing the plurality of positive sample images comprising images of image capturing devices comprises applying a machine learning algorithm to the positive sample plurality of images.

4. An apparatus according to claim 3, wherein the machine learning algorithm comprises a deep convolutional neural network.

5. An apparatus according to claim 3, wherein the machine learning algorithm comprises a support vector machine training algorithm.

6. An apparatus according to claim 3, wherein the machine learning algorithm is performed to determine if the captured image comprises an image capture device.

7. An apparatus according to claim 1, wherein causing the apparatus to change that which is provided for presentation on a display comprises ceasing to present an image that was presented immediately before the captured image was determined to comprise an image capture device.

8. An apparatus according to claim 1, wherein causing the apparatus to change that which is provided for presentation on a display comprises providing for presentation of only a portion of an image that was provided for presentation immediately before the captured image was determined to comprise an image capture device.

9. An apparatus according to claim 1, wherein the apparatus is further caused to receive a plurality of negative sample images not including images of image capture devices to facilitate machine learning for determining the presence of an image capture device in an image.

10. A method comprising:
receiving a plurality of positive sample images comprising images of image capture devices;
receiving a captured image from an image capture device;
determining if the captured image comprises an image of an image capture device; and
causing an image provided for presentation on a display to be changed in response to the captured image comprising an image of an image capture device.

11. A method according to claim 10, further comprising:
analyzing the plurality of positive sample images comprising images of image capture devices to learn to detect images of image capture devices in a captured image.

12. A method according to claim 11, wherein analyzing the plurality of positive sample images comprising images of image capture devices comprises applying a machine learning algorithm to the plurality of positive sample images.

13. (canceled)

14. (canceled)

15. A method according to claim 12, wherein the machine learning algorithm is performed to determine if the captured image comprises an image capture device.

16. A method according to claim 10, wherein causing an image provided for presentation on a display to be changed comprises ceasing to present an image that was presented immediately before the captured image was determined to comprise an image capture device.

17. A method according to claim 10, wherein causing an image provided for presentation on a display to be changed comprises providing for presentation of only a portion of an image that was provided for presentation immediately before the captured image was determined to comprise an image capture device.

18. A method according to claim 10, further comprising receiving a plurality of negative sample images not including images of image capture devices to facilitate machine learning for determining the presence of an image capture device in an image.

19. A computer program product comprising at least one non-transitory computer-readable storage medium having computer-executable program code instructions stored therein, the computer-readable program code instructions comprising program code instructions for:
receiving a plurality of positive sample images comprising images of image capture devices;
receiving a captured image from an image capture device;
determining if the captured image comprises an image of an image capture device; and
causing an image provided for presentation on a display to be changed in response to the captured image comprising an image of an image capture device.

20. A computer program product according to claim 19, further comprising program code instructions for:
analyzing the plurality of positive sample images comprising images of image capture devices to learn to detect images of image capture devices in a captured image.

21. A computer program product according to claim 20, wherein the program code instructions for analyzing the plurality of positive sample images comprising images of image capture devices comprises program code instructions for applying a machine learning algorithm to the plurality of positive sample images.

22. (canceled)

23. (canceled)

24. A computer program product according to claim 21, wherein the machine learning algorithm is performed to determine if the captured image comprises an image capture device.

25.-36. (canceled)
